(19) United States
(12) Patent Application Publication
(10) Pub. No.: US 2020/0382218 A1
(43) Pub. Date: Dec. 3, 2020

(54) DEVICE AND METHOD FOR COMMUNICATION BETWEEN A HANDHELD APPARATUS WITH FLASH AND ELECTRONIC EQUIPMENT WITH LUMINOSITY RECEIVER

(71) Applicant: EXATRON INDÚSTRIA ELETRÔNICA LTDA., Porto Alegre (BR)

(72) Inventor: Jorge Luis DEMOLINER, Porto Alegre (BR)

(21) Appl. No.: 16/857,222

(22) Filed: Apr. 24, 2020

(30) Foreign Application Priority Data
Jun. 3, 2019 (BR) 10 2019 011429 0

(51) Int. Cl. H04B 10/69; H04B 10/116; H04B 10/50

(52) U.S. Cl. CPC H04B 10/691; H04B 10/502; H04B 10/116

(57) ABSTRACT

The communication method of the invention is point-to-point with low data transfer rate by means of modulation of the light emitted by a handheld apparatus flash with processing capability for transmission of information, commands and configurations of electronic equipment provided with luminous receivers. The emission operation is processed by an application installed in the handheld apparatus, such as, smartphone, tablet or similar. The reception operation is processed by the electronic equipment to be configured. The emission device included in a handheld apparatus with an application installed and provided with a flash. The receiving device is mounted inside the electronic equipment to be configured, and it is formed by a power supply (A), a luminosity sensor (B) that monitors the luminosity variations emitted by the handheld apparatus flash (F) irrespective of the environment, an analog-digital converter (C) that transforms the analog signals coming from the luminosity sensor into digital signals, a microcontroller (D) that executes the reception firmware and processes the digital signals and the electronic equipment or load control to be adjusted (E).

### CROSS-REFERENCE TO RELATED APPLICATIONS

The present application claims priority of Brazilian Patent Application No. BR 10 2019 0114290, filed Jun. 3, 2019, the contents of which are incorporated by reference herein.

The present invention refers to a communication device and method with low data transfer rate employing modulation of flash light of a handheld apparatus of the type of smartphone, tablet or similar with electronic equipment provided with luminous receiver.

### DESCRIPTION OF THE STATE OF ART

For several years electronic products which required analogical adjustments, temporal and non-digital effects, employed the use of potentiometers, jumpers or even connectors in order to permit the choice of the reference internal parameters of these signals. Thereby, we can understand that until this moment there are many methods of transforming analog signals into signals for control, programming and configuration of a determined product.

The most frequent methods applied for configurations adjustment of electronic products are the following:

methods with employment of potentiometers—these are methods in which we can often alter a determined operation parameter of a product by varying the electric resistance, which is read inside the equipment, and this impedance alteration sensed by the receiver provides the due parametric alteration, for example: volume of an auto radio;

methods with employment of jumpers—these use a type of connector, which can be open or closed for an execution of the state change among its elements; the receiver of these elements identifies a logic and determined sequence of a function, for example, delay time, passage into test of a determined product, etc.

Nevertheless, conventional methods for adjustment of electronic apparatuses configurations present the following drawbacks:

they require physical intervention of a user or even of a skilled person in configuration and adjustments, what may create a technical dependence;

user physical intervention can further generate risks for the safety of end users, in view of the possibility of errors in adjustments and contact with energized parts;

they employ physical means which require high manufacture costs, increase the volume and weight of electronic apparatuses and do not directly account for improving their performances;

they make available limited adjustment parameters.

Patent documents WO 2015/094986, WO 2015/116420 and WO 2016/043573 relate to high frequency visible light communication systems. The system comprises light emitters and receivers, which provide communication between smart devices and/or remote servers. However, these documents do not foresee the use of a smartphone flash and are not capable of altering the configuration of an electronic equipment provided with a luminosity receiver, for example, a photoelectric relay or a presence sensor and automatic illumination controllers.

Patent document WO 2017/062925 relates to a communication system employing a smartphone which transmits authentication information to an access control electronic locking device. The system comprises a LED of a smart device and a wireless networking radio for exchanging information with a remote server. However, these documents do not foresee the use of a smartphone flash to alter the configuration of an electronic equipment provided with a luminosity receiver, for example, a photoelectric relay or a presence sensor and automatic illumination controllers.

Nowadays, equipment that adds high technology has been increasingly made available. Examples are cell phones that no longer have physical keys, equipment and appliances ever more operate digitally, whose analogy is implicit to the end user. In everyday life, when we try to learn about something, we use smartphones to access search pages to answer our questions almost instantly.

### INVENTION SOLUTION

The objective of the present invention is a communication device and method with low data transfer rate by means of flash light modulation of a handheld apparatus with an electronic equipment provided with a luminous receiver.

Based on the above paradigms, a device and method of point-to-point communication with low data transfer rate are developed by modulating the light emitted by the flash of a handheld apparatus with processing capacity such as a smartphone, tablet or similar, for the transmission of information, commands and configurations of electronic equipment with luminous receivers.

### SUMMARY OF THE INVENTION

The communication method of the invention is point-to-point with low data transfer rate by means of modulation of the light emitted by a handheld apparatus flash with processing capability for transmission of information, commands and configurations of electronic equipment provided with luminosity receivers. The emission operation is processed by an application installed in the handheld apparatus, such as, smartphone, tablet or similar. The emission device is included in a handheld apparatus with an application installed and provided with a flash.

The reception operation is processed by the electronic equipment to be configured. The receiving device is mounted inside the electronic equipment to be configured, and it is formed by a power supply (A), a luminosity sensor (B) that monitors the luminosity variations emitted by the handheld apparatus flash (F) irrespective of the environment, an analog-digital converter (C) that transforms the analog signals coming from the luminosity sensor into digital signals, a microcontroller (D) that executes reception firmware and processes the digital signals and the electronic equipment or load control to be adjusted

The flash light data communication device and method of a handheld apparatus with an electronic equipment provided with a luminosity receiver of the invention result in the following advantages over the state of art:

they are quite simple and enable any user to select the parameters, configurations and other adjustments directly on the screen of his/her smartphone or similar;

the electronic equipment reads the luminosity pattern, it transfers the selected information on the screen of its apparatus to the receiver device, in an easy and quick way;

it dispenses with the physical intervention of the user without generating risks to the safety of the end user and without configuration errors;

it does not depend on physical means to perform adjustments to the configuration of the electronic equipment;

it allows for the adjustment of a large number of parameters;

it provides greater agility in equipment programming, since the software is intuitive and the user is not required to have a manual for each device to perform the configuration that is now done quickly and easily.

### BRIEF DESCRIPTION OF THE DRAWINGS

The flash light data communication device and method of a handheld apparatus for an electronic equipment of the invention are disclosed in detail based on the following attached drawings:

FIG. 1 shows a flowchart of the emission process;

FIG. 2 shows a flowchart of the reception process;

FIG. 3 shows a block diagram of the receiving device;

FIG. 4 shows an example of a block diagram of the receiving device mounted in a photoelectric relay;

FIG. 5 shows an example of a block diagram of the receiving device mounted in a presence sensor.

### DESCRIPTION OF AN EMBODIMENT

The following description uses the numbered elements in the drawing Figures to identify the elements and steps of use of the method:

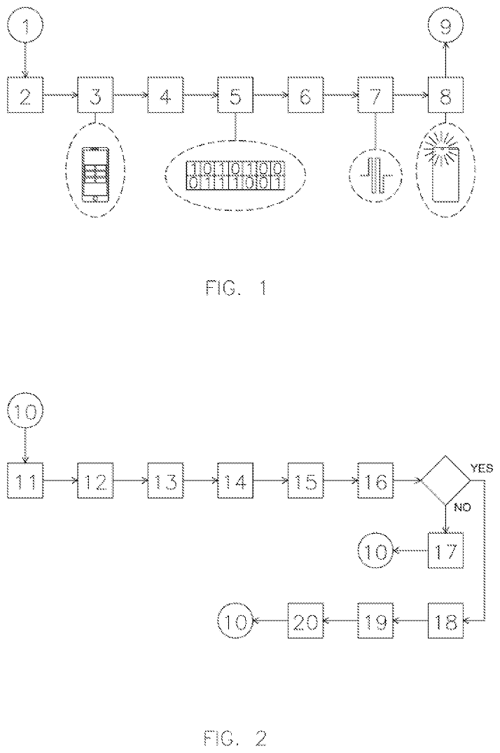

FIG. 1 illustrates the flowchart of emission operation of the communication method that complies with the following steps in sequence:

1. Start—start of the data emission operation;

2. Activation of the Application—selection and activation by the user of an application for performing the steps for an illumination device, such as a smartphone, which provides data transfer at a preferably low data transfer rate, by modulation of light emitted by a preferably handheld apparatus flash. The device has processing capability for transmission of information, commands, etc. such as the smartphone described herein installed in the handheld apparatus of a smartphone, tablet or similar type;

3. Selection of the Electronic Equipment—the user selects the equipment to be configured in the already activated application]. The final electronically controlled equipment which can be of an industrial line, such as a boiler; of a domestic line, such as an air conditioning unit and appliances in general; or, the safety and home automation; of a building and commercial line, such as photoelectric relays, motion sensors, among others. The selected “Electronic Equipment” (3) performs the parameters selected by the user.

4. Selection of the Adjustment Parameters—the user selects in the application adjustment parameters of the already selected electronic equipment. Those parameters include any desired parameters, as previously recorded in the Electronic Equipment (3) and used in industrial or domestic or home or commercial automation equipment, which can be controlled, such as temperature, actuation time, charging time, lighting level, heat motion sensitivity level, among others. The user selects, through the portable device interface of the application on the screen of a tablet, notebook, or smartphone, for example, the parameters to be set of the already selected Electronic Equipment (3), which can be any electronically controllable parameters, such as the charge time, brightness level, and heat motion sensitivity level. The user selects, through the interface of the portable device, the parameters to be adjusted in Electronic Equipment (3), and these parameters will be stored in the device to be configured (3), in a non-volatile memory component and, in an alternative technology, via supercap or battery, for example, after the communication process.

5. Payload assembly—assembly by the application of the data packet to be transmitted to the electronic device to be configured with data already selected by the user on the smartphone screen. The Data Packets (5) are the user-defined parameters set for the Electronic Equipment (3) when those parameters are converted to a modulated light pulse set (CW, continuous wave).

6. Allocation of the Camera/Led Service—the smartphone camera is actuated;

7. Payload codification—data packet is organized and coded by the application in the smartphone so that the electronic equipment to be programed recognizes the packet. The data packet (5) is converted to light pulse patterns by the application and transmitted via light signals to the Light Sensor (B), which converts the light pulses into analog pulses. Once these pulses reach the Analog-Digital Converter (C), they are converted into digital signals that are decoded into Microcontroller (D) commands for the Electronic Equipment (3). The decoded signal maybe possibly decoded by ASIC or a dedicated circuit.

8. Payload transmission—transmission of the data packet by the smartphone Led (flash) to a luminosity sensor of the electronic equipment to be configured. The light sensor (B) is an electrical component capable of detecting the ambient light variations and receives the light emitted, for example, by the smartphone's flash (F). The light sensor (B) can be a photo-transistor, photocell, photodiode, LDR (CdS), among others.

9. End—return to the initial step.

FIG. 2 illustrates a flowchart of the reception operation of the communication method, which complies with the following steps in sequence:

10. Start of the Data reception operation of the luminosity receiver;

11. Stand by—electronic equipment in the normal operation waiting for a recording request;

12. Analog-Digital Conversion—the light signal (analog) emitted by the smartphone flash is converted into a digital value in an A/D converter in the electronic equipment. The data packet (5) is converted to light pulse patterns by the application and transmitted via light signals to the Light Sensor (B) which transmits the signal to the digital analog converter (AD), which is responsible for converting the digital light pulses into analog signals so that they can be decoded by the Microcontroller (D). The analog-to-digital (AD) converter runs a predefined protocol long enough to convert the light pulse to digital ramp and can be started in a variety of ways, particularly by wake up by pin or wake up by function.

13. Decoding of the Logic Level—digital values coming from A/D conversion are converted into binary logic levels (0 or 1). There is a filter that accepts only values which are limited to a voltage value (light cannot be too weak or too strong);

14. Decoding of the Received Bits—The bits correspond to the state of the light emitter (max or min) analyzed over time when it is converted to an analog signal by the light sensor, forming groups of bits—data packets (5). This data packet (5) passes through the analog to digital converter (AD) (C) and is decoded by the Microcontroller. Bits coming from previous step are analyzed in the time domain and converted into communication protocol data, that is, in accordance with the time ratio between logical level 0 and logical level 1, the information received represents a determined element of the protocol (packet restrictors, invalid bits and etc.);

15. Payload assembly—the bits previously decoded and validated are sequentially and temporarily stored in a non-volatile reconciling medium so as to assemble the information packet for later analysis of the contents thereof;

16. Payload Decoding—having the data packet in hands (payload), the data in the data packet is fragmented in accordance with the protocol described below:

One example of a protocol used today is a protocol that, in the lower layer, uses the states light emission ON or light emission OFF, which means that there is no light modulation, using the same good and old technique of CW (continuous wave), used today by radio amateurs, HAM in radio operators, where the presence or absence of digital variant light over time is decoded.

In the case of radio amateurs and some satellites, other means are used, such as microwaves, sounds, etc.

The protocol is a serial protocol with variation of the pulse width (variation of the ON state time of the wave). The technique known worldwide for PWM (Pulse Width Modulation) is applied today), which includes a narrow width for the value “0” zero of the bit and a greater width for the “1” one of the bit. In this way, there is a transmission with greater immunity to noise and a more digitized decoding by microcontrollers, avoiding the need for loop controls such as sophisticated variable gain systems in light reception.

The basic frequency of PWM practiced today is 10 Hz.

While one could simply send data via MORSE CODE, the inventors hereof have not adopted that today, because there are many applications for smartphones and this way could be improperly used in the product.

Using a simple protocol of its own, messages between products are more immune to interference and digital misunderstandings of commands or programming and the information blocks-thus generated are later processed;

17. Error Message—if the packet received contains invalid information, as well as any other types of errors occurring during the communication process, the device is programmed to analyze information concerning an error and the device emits an error alert to the user through a signal (visual, acoustic, etc.);

18. Execution of the commands received; —if the received packet contains valid information, its respective commands will be processed and executed;

19. Storage of Parameters received—possible received data and/or parameters are stored in a non-volatile memory for future use;

20. Communication Message Accepted. —the device emits an alert of communication accepted to the user through some man-machine interface mechanism (visual, acoustic, etc.).

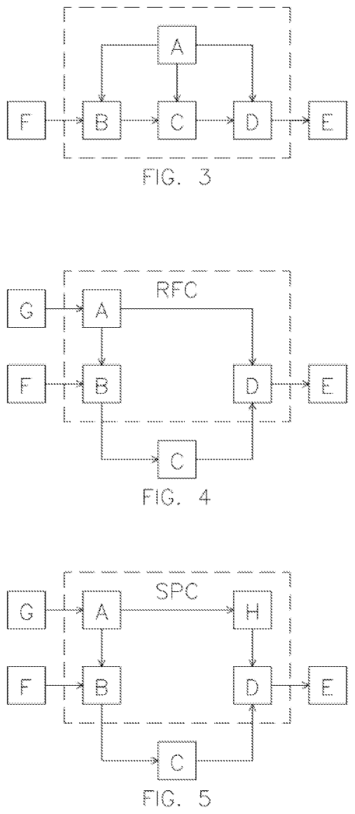

FIG. 3 illustrates a receiving device block diagram which is mounted inside the electronic equipment to be configured and which is formed by:

A. Power Supply: it provides power in the level of direct current suitable to the involved devices;

B. Luminosity Sensor—a system or product capable of monitoring variations of luminosity irrespective of the environment and which receives light emitted by the smartphone flash (F);

C. Analog-Digital Converter: it transforms the analog signals coming from block B into digital signals sent to block D;

D. Microcontroller: it executes reception firmware that processes the digital signals coming from the converter AD (C) for adjustment of parameters of the electronic equipment or of the load control device; The digital signal from the converter (C) is sent to the Microcontroller (D) where the firmware performs the parameters adjustment (temperature, operating time, amount of ambient light, delay time for activation, operating mode, Day or Night switches, etc) of the operation of the photoelectric relay and where the firmware performs the parameters adjustment (charging time on, lighting level and heat motion sensitivity level) of the operation of the presence sensor.

E. Adjustment of the configuration of the electronic equipment or of the load control.

FIG. 4 illustrates an example of applying the invention to a photoelectric relay. Blocks contained inside the dashed rectangle correspond to a conventional photoelectric relay (RFC) which is formed by a supply (A), a luminosity sensor (B), a microcontroller (D), an input (G) and a load (E) which will be actuated by relay (RFC). To the conventional photoelectric relay (RFC) an analog-digital converter (C) block is added which transforms the analog modulated light emitted by the smartphone flash (F) and received by the luminosity sensor (B) into digital signal. The digital signal from converter (C) is sent to microcontroller (D) where it is recorded the firmware that executes an adjustment of the parameters (quantity of ambient light, delay time for actuation, mode of operation—on during day or night) for operation of the photoelectric relay.

FIG. 5 illustrates an example of applying the invention to a presence sensor. Blocks contained inside the dashed rectangle correspond to a conventional presence sensor (SPC) which is formed by a supply (A), a luminosity sensor (B), a microcontroller (D), an input (F), a presence sensor (H) and a load (E) which will be actuated by sensor (SPC). To the conventional presence sensor (SPC) an analog-digital converter (C) block is added which transforms the analog modulated light emitted by the smartphone flash (F) and received by the luminosity sensor (B) into a digital signal. The digital signal from converter (C) is sent to microcontroller (D) where it is recorded. The firmware executes adjustment of the operation parameters (load time on, luminosity level and level of sensitivity to movement) of the presence sensor.

1. A system for communication between a handheld apparatus with flash to electronic equipment with a luminosity receiver comprising:
an emitting device comprising a handheld apparatus with processing capability, an LED flash in the apparatus and with an application installed in the apparatus;
a receiving device which is mounted inside electronic equipment to be configured and the receiving device is formed by:
A a power supply;
B a luminosity sensor connected with the power supply, the sensor being configured to monitor luminosity variations emitted by the handheld apparatus flash irrespective of the environment;
C an analog-digital converter that transforms the analog signals coming from the luminosity sensor into digital signals;
D a microcontroller that executes the reception firmware and processes the digital signals; and
E the electronic equipment or load control is to be adjusted.

2. A method for communication between a handheld apparatus with flash to electronic equipment with a luminosity receiver comprising providing a point-to-point communication method comprising a low data transfer rate by modulating of light emitted by a handheld apparatus flash, providing processing capability for transmission of information, commands and configurations of electronic equipment provided with luminosity receivers.

3. A method for communication between a handheld apparatus with flash and electronic equipment with the luminosity receiver, according to claim 2, further comprising:
emission operation of the communication method comprises the following steps:
1 start operation;
2 activating an application by the user of the handheld apparatus;
3 selecting the electronic equipment by the user in the application;
4 selecting the adjustment parameters by the user in the application;
5 assembly of a transmittable payload through the data packet application and to be transmitted to an electronic device to be configured;
6 allocating of a camera/Led service of the handheld apparatus;
7 coding of the payload through the application so as to be recognized by the electronic equipment to be configured;
8 transmitting the payload through a handheld apparatus flash to the luminosity sensor of the electronic equipment to be configured;
9 end.

4. A method for communication between a handheld apparatus with flash and electronic equipment with luminosity receiver according to claim 2, further comprising performing a reception operation of the communication method through the following steps:
10 start operation of the reception operation;
11 standby of the electronic equipment waiting for a recording request;
12 analog-digital conversion converting the light analog signal emitted by the handheld apparatus flash into digital value;
13 decoding the logic level of the digital values coming from the analog-digital conversion;
14 decoding the received bits coming from the decoding and converting the bits into communication protocol data;
15 assembling the payload of the previously decoded and validated bits, and assembling the information packet;
16 decoding the payload that fragments of the data packet in accordance with used protocol;
17 indicating by an error message if the received packet contains invalid information;
18 execution of the received commands in the communication protocol data;
19 storing received parameters in a non-volatile memory; and
20 communication that message has been accepted.

5. The device according to claim 1, wherein the handheld apparatus with flash comprises a smartphone.

6. The method according to claim 2, wherein the handheld apparatus with flash comprises a smartphone.
